(19) United States
(12) Patent Application Publication
(10) Pub. No.: US 2026/0046638 A1
(43) Pub. Date: Feb. 12, 2026

(54) NETWORK EQUIPMENT SOLUTION GENERATION UTILIZING NETWORK SIGNALS

(71) Applicant: Verizon Patent and Licensing Inc., Basking Ridge, NJ (US)

(72) Inventors: Subham Biswas, Maharashtra (IN); Saurabh Tahiliani, Uttar Pradesh (IN); Durgesh Kumar, Karnataka (IN)

(21) Appl. No.: 18/797,709

(22) Filed: Aug. 8, 2024

(51) Int. Cl. H04W 16/18; G06T 7/50; H04L 41/14; H04L 41/16

(52) U.S. Cl. CPC H04W 16/18; G06T 7/50; H04L 41/145; H04L 41/16; G06T 2207/20084; G06T 2207/30184

(57) ABSTRACT

One or more computing devices, systems, and/or methods for network equipment solution generation utilizing network signals are provided. Network signals collected by devices within a location are evaluated by a neural network to generate contextually aware pixel values forming a vision map of the location. The contextually aware pixel values and/or the vision map are evaluated to generate a coverage map corresponding to regions of low signal coverage and obstacles proximate the regions. A simulation of network equipment operating at the location is performed using the coverage map to generate a simulation result. The simulation result is used to generate an installation plan to install network equipment at the location.

### BACKGROUND

An organization may have network requirements that are to be provided by a network service provider for the organization so that user equipment at a premises of the organization can connect to and communicate over a network. The network requirements may relate to network speed, network bandwidth, wireless coverage within certain locations of a building, etc. In this way, the network service provider may install various types of network equipment and peripherals at a location, such as routers, switches, network cables, power lines, etc.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for network equipment solution generation utilizing network signals, in accordance with an embodiment of the present technology;

FIG. 2 is a flow chart illustrating an example method for network equipment solution generation utilizing network signals, in accordance with an embodiment of the present technology;

FIG. 3 illustrates an example of a system for network equipment solution generation utilizing network signals, where an installation planning component generates an installation plan, in accordance with an embodiment of the present technology;

FIG. 4 illustrates an example of a system for network equipment solution generation utilizing network signals, where a first neural network is trained by a second neural network, in accordance with an embodiment of the present technology;

FIG. 5A illustrates an example of a system for network equipment solution generation utilizing network signals, where a first neural network generates a vision map, in accordance with an embodiment of the present technology;

FIG. 5B illustrates an example of a system for network equipment solution generation utilizing network signals, where a second neural network trains a first neural network, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for network equipment solution generation utilizing network signals. Network deployment is an important function of a network service provider. In order to provide a customer such as an organization with network communication functionality, the network service provider may deploy, install, and configure network equipment at a location of the customer. Conventional network equipment solutioning is performed manually by agents that must identify network requirements of the customer, determine what network equipment will satisfy the network requirements, construct an installation plan for installing the network equipment that takes into account what network equipment to install at particular installation locations, and deployment. This manual process is very time consuming and is prone to errors because the agent may not have physical access to the location (e.g., an agent of the network service provider may not have physical access to offices where network communication functionality is to be provided). Also, the customer may be reluctant to provide photography and/or videography of sensitive office locations, and thus the agent may not have adequate information to create an accurate/complete installation plan tailored to the location and the network requirements of the customer.

The disclosed techniques overcome these technical challenges by implementing custom trained and tailored neural networks to process network signals for generating installation plans such as recommendations of equipment forecasts of network equipment to install at a location. The network signals may be collected from devices operating at the location (e.g., at least 3 user equipment with transmitter/receiver functionality for triangulation purposes). The network signals are input into a neural network that has been trained to generate visual maps of locations based upon training network signals and training images. In this way, the neural network is implemented to generate a visual map of the location based upon the network signals exchanged by the devices at the location. The visual map is a visual depiction/representation of the location (e.g., a visualization of an office space) derived from the network signals of the devices (e.g., wireless communication signals of devices wireless communicating with one another).

The visual map is evaluated to generate a coverage map that represents regions of low signal coverage in the location and obstacles (e.g., objects such as walls through which wireless signals may not easily propagate). A computer implemented simulation of network equipment such as routers operating at the location is performed based upon the coverage map. The simulation may be used to identify installation locations for network equipment that would provide desired/optimal signal coverage for the location (e.g., installing a router on a specific wall). In this way, an installation plan is generated to specify what network equipment to install, what peripherals to install (power cables, clips, network cables, etc.), and installation locations for the network equipment and/or peripherals. The installation plan may be provided to the customer and/or may be automatically implemented to deploy and/or configure the network equipment at the location. The installation plan is more accurate and provides a more efficient solution (e.g., an installation configuration that provides better signal coverage) than manual guesswork performed by an agent without physical access to the location.

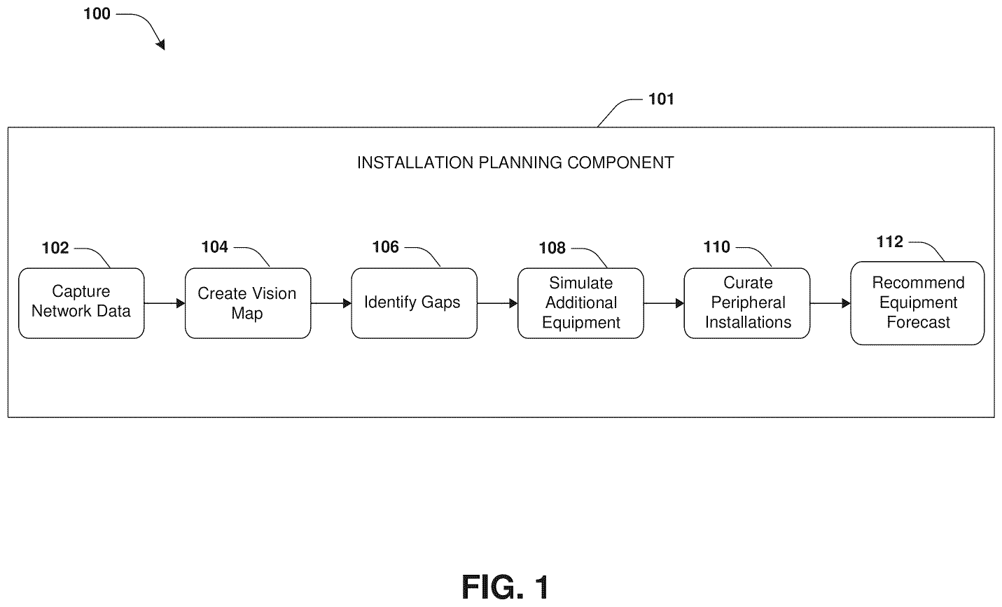

FIG. 1 illustrates an example of a system 100 for network equipment solution generation utilizing network signals. The system 100 includes an installation planning component 101 that may implement various neural networks or other machine learning models to generate installation plans such as to recommend 112 an equipment forecast of network equipment to install at a location (e.g., a plan to install routers, hubs, switches, modems, repeaters, gateways, cables, mounts, etc. at an office location). The installation planning component 101 may capture 102 network data from devices within the location. The network data may include information related to network signals exchanged between the devices (e.g., information related to wireless signals transmitted and received between user equipment at the location).

The installation planning component 101 executes a neural network to process the network data to create 104 a vision map of the location (e.g., a visual representation of the location). The vision map is created 104 from contextually aware pixel values generated by the neural network processing the network data. The contextually aware pixel values are values for pixels (e.g., a pixel with RBG information) forming the vision map. The contextually aware pixel values are determined by the neural network based upon changes in magnitude of signal values used to understand porosity, phase and frequency with a time component used to measure distance of reflecting points, and/or other information and waveforms related to how wireless signals, transmitted by the devices at the location, physically interact (e.g., reflect or propagate) with objects within the location. For example, the other information may relate to how a wireless signal transmitted from a first device propagates through a wall to a second device receiving the wireless signal, how a wireless signal transmitted from a device is reflected by an object within the location and is subsequently received back by the device, etc. This information such as network signals (e.g., a set of numerical data) and underlying parameters such as amplitude, phase, and frequency are encoded into vectors that are processed by the neural network for generating the contextually aware pixel values (e.g., vectors are utilized to predict probable pixels representing objects within the location such as walls, a chair, a floor, a window, etc.) forming the vision map.

The installation planning component 101 may process the vision map to identify 106 gaps. The gaps correspond to network gaps associated with regions of low network speed or low network signal coverage. For example, the location may be an office room determined to be similar to other office rooms with historically low network speed/signal coverage due to the office room being separated from a wireless router by multiple walls and/or non-porous objects. The presence of edges and contours within the vision map can be used to identify objects that may act as obstacles with respect to wireless signals. In this way, previously identified/historic regions of low or high wireless signal speed and coverage are used to identify similar regions within the vision map. In some embodiments, the gaps (e.g., regions of low signal/coverage) may be represented as a coverage map. The coverage map may identify the location of objects/obstacles within the gaps such as the regions of low signal/coverage.

The installation planning component 101 may utilize the gaps, such as by processing the coverage map, to execute 108 a computer simulation of how network equipment would operate within the location. The computer simulation may indicate how signal strength and coverage would increase or decrease in certain regions based upon network equipment (e.g., routers, repeaters, extenders, access points, switches) being installed at various installation locations within the location. A result of the simulation can be used to identify certain network equipment and installation locations for the location that will provide desired/improved network signal coverage and signal strength. The installation planning component 101 may also curate 110 peripheral installations such as by identifying what peripherals are needed to install the network equipment at the installation locations (e.g., an amount and install location of power lines, network cables, cable clips, switches, a mount, etc.). In this way, the installation planning component 101 recommends 112 an equipment forecast such as an installation plan that lists out network equipment, peripherals, and installation locations for the location.

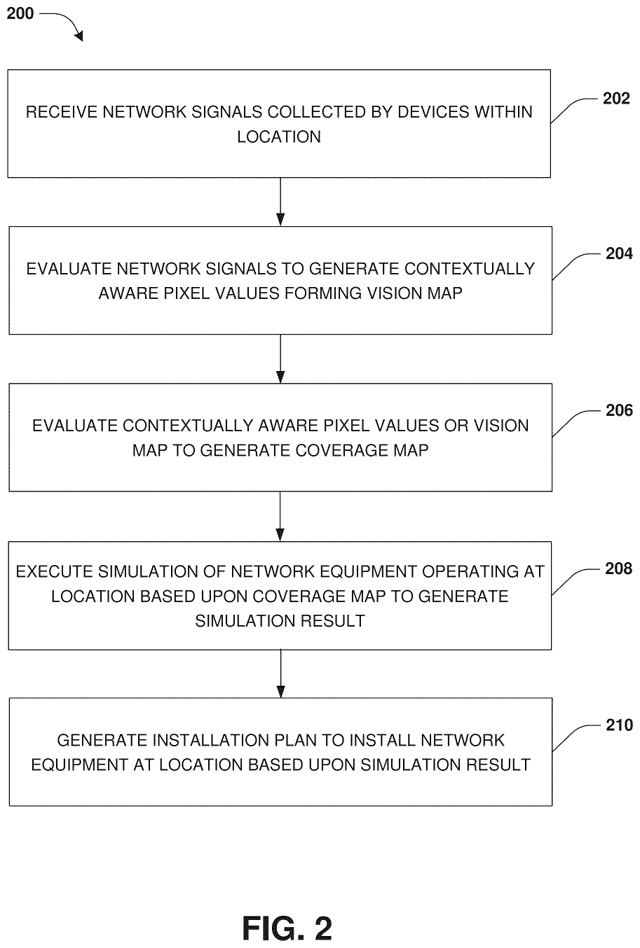

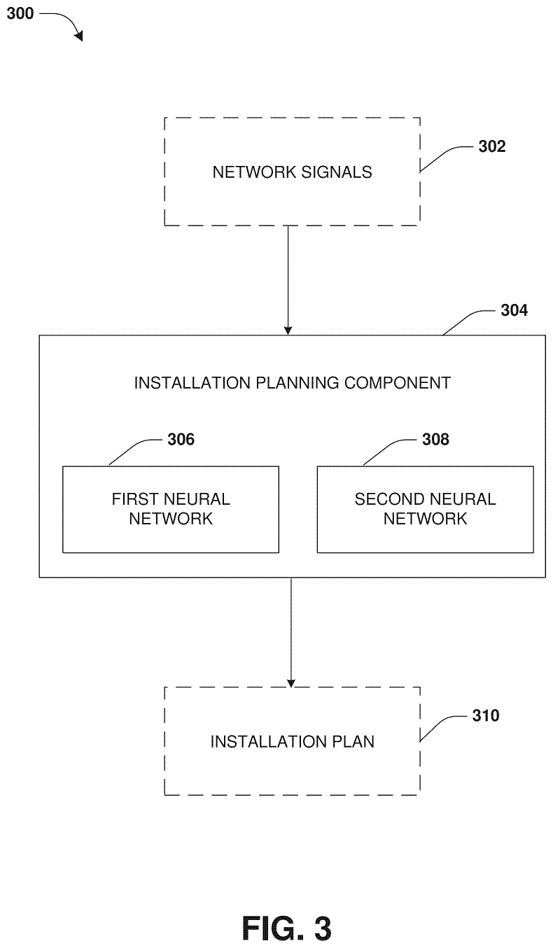

FIG. 2 is a flow chart illustrating an example method 200 for network equipment solution generation utilizing network signals, which is described in conjunction with system 300 of FIG. 3. An installation planning component 304 may be configured to implement a first neural network 306 for generating and/or executing an installation plan 310 for a location based upon network signals 302 received from devices at the location. The installation planning component 304 may be capable of generating a more precise installation plan 310 of what network equipment to install at determined installation locations in order to provide desired/improved communication network coverage at the location. That installation plan provides a more effective network installation that may result in improved network coverage and signal strength at the location compared to manual attempts by an agent to create an installation plan where the agent does not have physical access to the location or the ability to test network equipment at the location as part of developing the installation plan.

The network signals 302 may relate to information and statistics of wireless communication signals transmitted and received by devices (e.g., user equipment) at the location. The network signals 302 and various parameters such as amplitude, phase, and frequency parameters along with a time component are encoded by the installation planning component 304 into vectors. The vectors are input into the first neural network 306 that has been trained using a second neural network 308 to generate vision maps (e.g., visual representations/images of a location) based upon input network signals. In this way, the installation planning component 304 receives the network signals 302 collected by the devices within the location (e.g., retrieves the network signals 302 from the devices, from a database storing network signals from devices, etc.), during operation 202 of method 200.

During operation 204 of method 200, the network signals 302 (e.g., the vectors) are evaluated by the first neural network 306 to generate contextually aware pixel values forming a vision map of the location. The contextually aware pixel values may comprise values for pixels of the vision map (e.g., RBG values) that are derived from the network signals and underlying parameters (e.g., amplitude, phase, frequency, and a time component) embedded within the vectors processed by the first neural network 306. The first neural network 306 is capable of outputting the contextually aware pixel values that form the vision map that visually represents the location such as walls, windows, a chair, a couch, etc. In some embodiments, changes in amplitude of the network signals 302 are evaluated to determine porosity of objects within the location (e.g., a significant drop in amplitude of a wireless signal that has propagated through an object may indicate that the object is not porous and is an obstruction/obstacle). The porosity of the objects may be utilized to generate the contextually aware pixel values. In some embodiments, phase, frequency, and time component data is evaluated to measure distance of reflecting points within the location (e.g., a wireless communication signal reflecting off a wall, which is used to measure a distance from the device transmitting the wireless communication signal and the wall). The distance of the reflecting points may be utilized to generate the contextually aware pixel values.

Because different materials and surface types (e.g., curved, flat, etc.) interact differently with network signals, each signal hit can be used with pixel gradients to map surface curvature and objects within a signal feed range. The vision map is a reconstruction of objects detected in 3 dimensions and portrayed using network signals (e.g., different parts of a sofa, table, wall, etc.) and reflected signals with different amplitude, frequency, etc.

In some embodiments, a privacy preference may be used to determine whether the contextually aware pixel values are to be used to generate/form the vision map. If the privacy preference indicates that visualizations of the location are not to be generated, then merely the contextually aware pixel values may be created and maintained for further processing. Otherwise, the contextually aware pixel values are used to generate the vision map that visually represents the location.

During operation 206 of method 200, the contextually aware pixel values and/or the vision map are evaluated to generate a coverage map correspond to regions of low signal coverage where obstacles may be located. For example, the vision map is evaluated to identify regions of low signal coverage based upon the regions having features corresponding to features of historically low signal coverage (e.g., the first neural network 306 may have been trained to identify regions of low signal coverage). Obstacles within these regions of low signal coverage may be identified based upon the contextually aware pixel values and/or the vision map. In this way, the coverage map is generated. The coverage map is the reconstruction of network strength (e.g., coverage) using the vision map to identify regions of low/no network reach such as where an amplitude of a signal is low in certain regions (e.g., behind a sofa, behind a wall, a blind spot, etc.).

During operation 208 of method 200, a simulation of network equipment operating at the location is executed. The simulation may be a computer simulation executed by the installation planning component 304. The computing simulation may run simulation tests to determine how wireless signals are propagated throughout the location based upon simulated network equipment being placed at various install locations. The simulation may determine signal strength, quality, and/or other metrics/properties. In this way, simulation results may be generated and evaluated to determine what network equipment and install locations would satisfy requirements of a communication network deployed at the location (e.g., installation of 3 routers and a switch at certain locations would provide desired/required wireless network connectivity, bandwidth, and speed with a budget set by a customer).

In some embodiments, the installation planning component 304 utilizes depth sensing from spatial map information associated with or derived from the network signals 302 in order to identify peripherals and peripheral install locations to include within the installation plan 310. The peripherals may include power lines, Fiber/CAT cables, mounts, network switches, wire clips, etc. In some embodiments, depth perception is simulated to identify the peripherals and peripheral install locations (e.g., a switch may be needed if there are multiple routers, and thus power and other cables may be needed for the routers and switch).

During operation 210 of method 200, the installation planning component 304 generates the installation plan 310, which may include a list of network equipment to install, a list of peripherals to install, install locations for the network equipment and/or the peripherals, a map populated with icons/representations of the network equipment and peripherals at install locations, etc. The installation plan uses the vision map and coverage map to create a list of equipment, along with approximate positions for installing such equipment. In some embodiments, the installation plan 310 may be transmitted to a computing device for display through a user interface (e.g., the installation plan 310 may be provided to an agent for review or editing where the agent can add, remove, or change network equipment and/or peripherals, a customer for approval, etc.). In some embodiments, the installation plan 310 may be executed to deploy and/or configure the network equipment and/or peripherals at the location.

The ability of the first neural network 306 to output a vision map closely resembling the actual location may be improved through training. In some embodiments, the first neural network 306 is trained by the second neural network 308 to reconstruct original images (training images used for training the first neural network 306) depicting locations and network signals of devices within those locations (e.g., training network signals). The second neural network 308 may be used to train the first neural network 306, such as using the original images (training images) of the locations and the network signals of those locations.

The second neural network 308 takes the vision map as input, and classifies pixels of the vision map with pixel classifications. The pixel classifications indicate whether pixels are synthetically generated pixels (e.g., the first neural network 306 incorrectly output pixels that are blurry, do not match surrounding pixels, pixels with colors that do not match corresponding pixels of the original image, etc.) or original image pixels (e.g., pixels with similar colors as corresponding pixels of the original image, pixels that blend with surrounding pixels, etc.). In some embodiments, the pixel classifications are assigned based upon how similar the pixels of the vision map are to pixels of the original image. In some embodiments, a pixel classification is assigned to a pixel based upon contextually aware surrounding pixel values of pixels surrounding the pixel (e.g., does the pixel blend with surrounding pixels). The pixel classifications are used to train the first neural network 306. In some embodiments, a loss function may be executed to calculate a difference between an actual value in the original image (e.g., a pixel value) used to train the first neural network 306 and a predicted pixel value determined by the first neural network 306 (e.g., a contextually aware pixel value). The difference is back-propagated for training the first neural network 306.

In some embodiments of training the first neural network 306, the second neural network 308 evaluates magnitudes of the contextually aware pixel values in order to identify porosity information of objects depicted by the visual map (e.g., a porosity of a chair). The second neural network 308 uses the porosity information to predict whether each pixel is contextually relevant or contextually irrelevant to surrounding pixels. Pixels that are predicted to be contextually irrelevant (e.g., synthetically generated pixels) are flagged (e.g., assigned an indicator, stored within a list, etc.) as flagged pixels for training the first neural network 306.

In some embodiments of training the first neural network 306, the second neural network 308 evaluates gradients of the contextually aware pixel values in order to identify shape information of objects depicted by the visual map. The second neural network 308 uses the shape information to predict whether each pixel is contextually relevant or contextually irrelevant to surrounding pixels. Pixels that are predicted to be contextually irrelevant (e.g., synthetically generated pixels) are flagged as flagged pixels for training the first neural network 306.

As part of training the first neural network 306, the synthetically generated pixels (e.g., the flagged pixels) are used to train the first neural network 306 such as by reducing weights, parameters, or other functionality used by the first neural network 306 to generate such pixels that do not correspond to the original image. In this way, the first neural network 306 is trained to generate vision maps that more accurately represent actual locations.

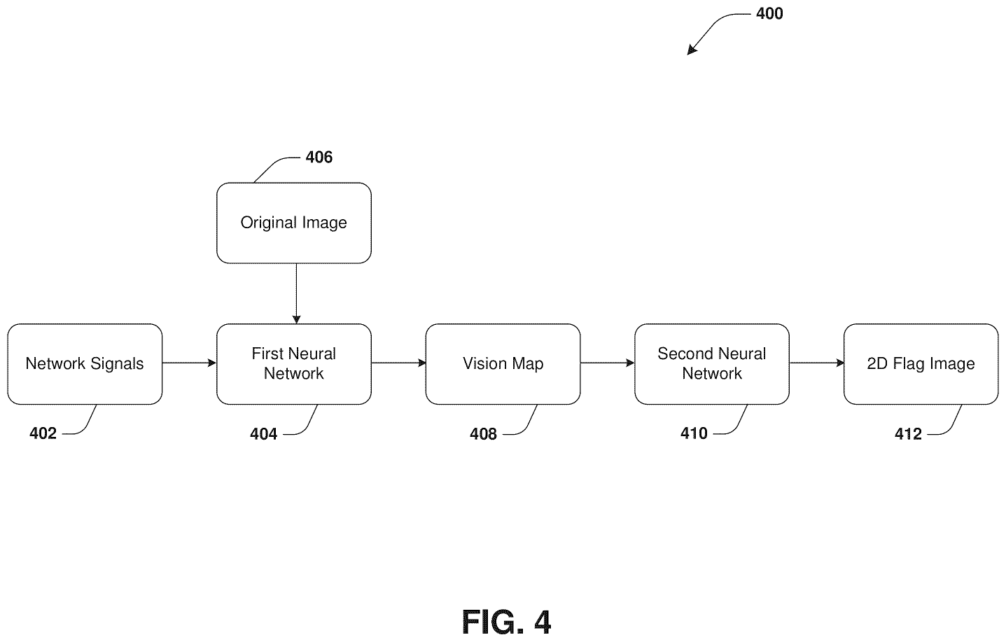

FIG. 4 illustrates an example of a system 400 for network equipment solution generation utilizing network signals, where a first neural network 404 is trained by a second neural network 410. The first neural network 404 may be trained on original images of locations for which network signals of devices operating at the locations are known (e.g., training images and training network signals), such as original image 406 of a location at which network signals 402 were captured from devices operating at that location. The first neural network 404 processes the network signals 402 to generate a vision map 408. The network signals 402 may comprise numerical data that is encoded with underlying parameters such as amplitude, phase, and frequency into vectors that are processed by the first neural network 404.

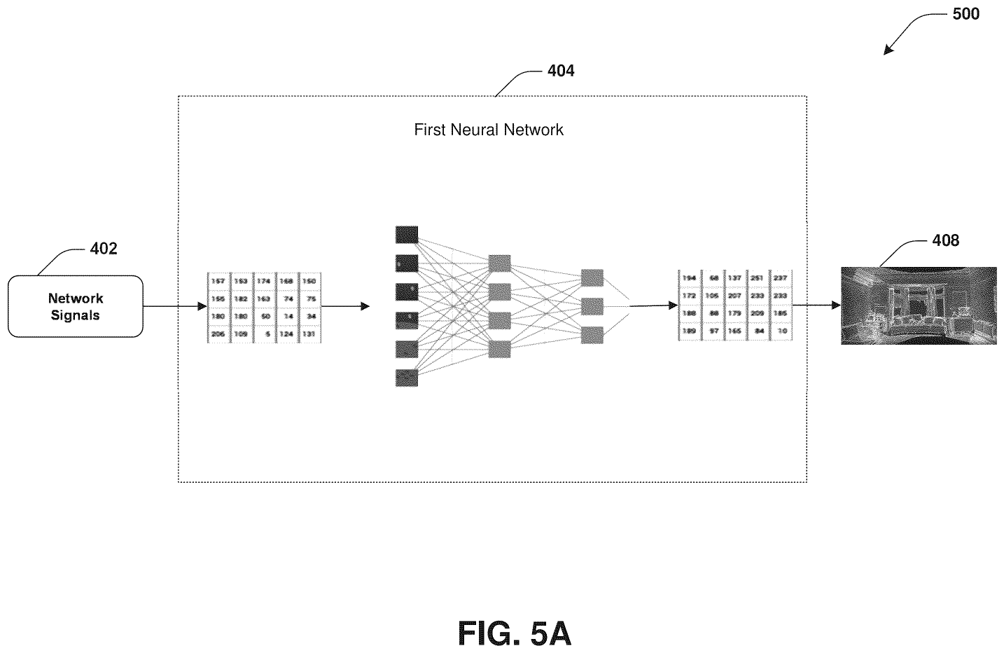

As part of training, the first neural network 404 learns to identify contextual awareness of the location using changes in signal parameters from multiple devices at the location, such as changes in magnitude to understand porosity, changes in phase and frequency along a time component to measure distance of reflecting points, etc. This contextual awareness is used to predict probable pixels as contextually aware pixel values forming the vision map 408. A loss function for the network is implemented to calculate a difference between actual values in the original image 406 and the predicted contextually aware pixel values. The difference is back-propagated to the network so that predictions by the first neural network 404 are improved to become closer to an actual visual orientation of the original image 406, which may be iteratively performed until a loss is minimized. FIG. 5A illustrates an embodiment 500 of the first neural network 404 processing the network signals 402 to generate the contextually aware pixel values forming the vision map 408.

The second neural network 410 is trained to identify contextual awareness of each pixel to its surroundings, such as by looking at the magnitude of a pixel value to understand porosity, the gradient of a pixel change to understand shape (e.g., gradient corresponding to edges of different objects in the image, and edge points corresponding to changes in color readings). This information is input into the second neural network 410 to predict whether each contextually aware pixel value forming the vision map 408 is contextually suitable or not to its surroundings (e.g., contextually relevant or contextually irrelevant). In particular, for each pixel value, a surrounding set of pixels are evaluated to see if any region appears to be synthetically generated or is more similar to the original image 406. The position and values of pixels is compared with surrounding pixels as additional context to see if the pixel(s) are blurry or do not visually appear how they are supposed to look with respect to the original image 406, and thus the pixels are flagged and/or classified as contextually irrelevant. Such pixels are tracked within a data structure such as a 2D flag image 412 used to further train the first neural network 404. FIG. 5B illustrates an embodiment 520 of the second neural network 410 processing the vision map 408 to generate the 2D flag image 412 with flags set to values indicating whether the corresponding pixels are contextually relevant or contextually irrelevant (e.g., a 0 value for contextually irrelevant and a 1 value for contextually relevant). The 2D flag image 412 is then used to train the first neural network 404 such as to discourage weights, parameters, and/or functionality used to generate the contextually irrelevant pixels (e.g., reduce weights, remove parameters, etc.) and/or encourage weights, parameters, and/or functionality used to generate the contextually relevant pixels (e.g., increase weights).

According to some embodiments, a method is provided. The method includes receiving network signals collected by devices within a location; evaluating the network signals, by a first neural network, to generate contextually aware pixel values forming a vision map of the location; evaluating at least one of the contextually aware pixel values or the vision map to generate a coverage map corresponding to regions of low signal coverage and obstacles proximate the regions; executing a simulation of network equipment operating at the location based upon the coverage map to generate a simulation result; and generating an installation plan to install the network equipment at the location based upon the simulation result.

According to some embodiments, the method includes determining porosity of objects within the location based upon changes in magnitude of the network signals; and utilizing the porosity of the objects to generate the contextually aware pixel values.

According to some embodiments, the method includes evaluating phase, frequency, and time component data to measure distance of reflecting points; and utilizing the distance of the reflecting points to generate the contextually aware pixel values.

According to some embodiments, the method includes encoding the network signals, amplitude parameters, phase parameters, and frequency parameters into vectors for input into the first neural network.

According to some embodiments, the method includes executing a loss function to calculate a difference between an actual value in an original image used to train the first neural network and a predicted pixel value determined by the first neural network based upon the original image; and back-propagating the difference for training the first neural network.

According to some embodiments, the method includes utilizing depth sensing from spatial map information to identify a peripheral and peripheral install location to include within the installation plan.

According to some embodiments, the method includes deploying the network equipment to the location based upon the installation plan.

According to some embodiments, the method includes configuring the network equipment at the location based upon the installation plan.

According to some embodiments, the method includes utilizing a second neural network to train the first neural network, wherein the second neural network classifies pixels of the visual map to create pixel classifications indicating whether the pixels are synthetically generated pixels or original image pixels based upon contextually aware surrounding pixel values; and training the first neural network based upon the pixel classifications.

According to some embodiments, the method includes evaluating, by the second neural network, magnitudes of the contextually aware pixel values to identify porosity information of objects depicted by the visual map; utilizing, by the second neural network, the porosity information to predict whether each pixel is contextually relevant or contextually irrelevant to surrounding pixels; and flagging pixels predicted to be contextually irrelevant as flagged pixels for training the first neural network.

According to some embodiments, the method includes evaluating, by the second neural network, gradients of pixels to identify shape information of objects depicted by the visual map; utilizing, by the second neural network, the shape information to predict whether each pixel is contextually relevant or contextually irrelevant to surrounding pixels; and flagging pixels predicted to be contextually irrelevant as flagged pixels for training the first neural network.

According to some embodiments, the method includes executing a loss function to calculate a difference between an actual value in an original image used to train the first neural network and a predicted pixel value output by the first neural network; and back-propagating the difference for training at least one of the first neural network or the second neural network.

According to some embodiments, a system comprising one or more processors configured for executing the instructions to perform operations, is provided. The operations include receiving network signals collected by devices within a location; evaluating the network signals, by a first neural network, to generate contextually aware pixel values forming a vision map of the location; evaluating at least one of the contextually aware pixel values or the vision map to generate a coverage map corresponding to regions of low signal coverage and obstacles proximate the regions; executing a simulation of network equipment operating at the location based upon the coverage map to generate a simulation result; and generating an installation plan to install the network equipment at the location based upon the simulation result.

According to some embodiments, the operations include utilizing a second neural network to train the first neural network, wherein the second neural network classifies pixels of the visual map to create pixel classifications indicating whether the pixels are synthetically generated pixels or original image pixels based upon contextually aware surrounding pixel values; and training the first neural network based upon the pixel classifications.

According to some embodiments, the operations include transmitting the installation plan to a computing device for display through a user interface.

According to some embodiments, the operations include determining porosity of objects within the location based upon changes in magnitude of the network signals; and utilizing the porosity of the objects to generate the contextually aware pixel values.

According to some embodiments, the operations include evaluating phase, frequency, and time component data to measure distance of reflecting points; and utilizing the distance of the reflecting points to generate the contextually aware pixel values.

According to some embodiments, a non-transitory computer-readable medium storing instructions that when executed facilitate performance of operations, is provided. The operations include receiving network signals collected by devices within a location; evaluating the network signals, by a first neural network, to generate contextually aware pixel values forming a vision map of the location; evaluating at least one of the contextually aware pixel values or the vision map to generate a coverage map corresponding to regions of low signal coverage and obstacles proximate the regions; executing a simulation of network equipment operating at the location based upon the coverage map to generate a simulation result; and generating an installation plan to install the network equipment at the location based upon the simulation result.

According to some embodiments, the operations include deploying the network equipment to the location based upon the installation plan.

According to some embodiments, the operations include utilizing a second neural network to train the first neural network, wherein the second neural network classifies pixels of the visual map to create pixel classifications indicating whether the pixels are synthetically generated pixels or original image pixels based upon contextually aware surrounding pixel values; and training the first neural network based upon the pixel classifications.

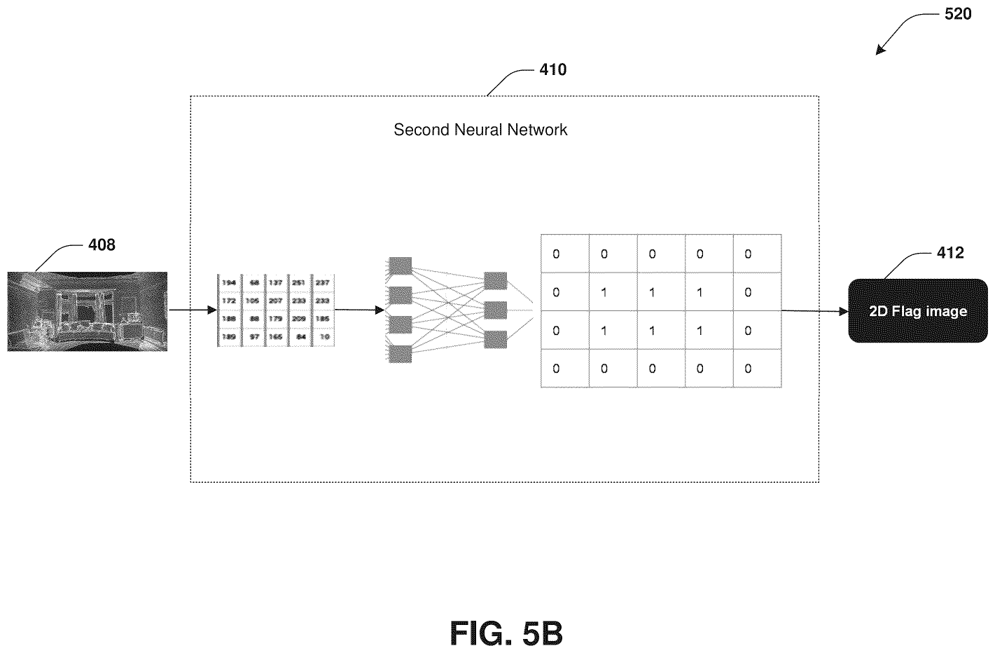

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of example system 300 of FIG. 3.

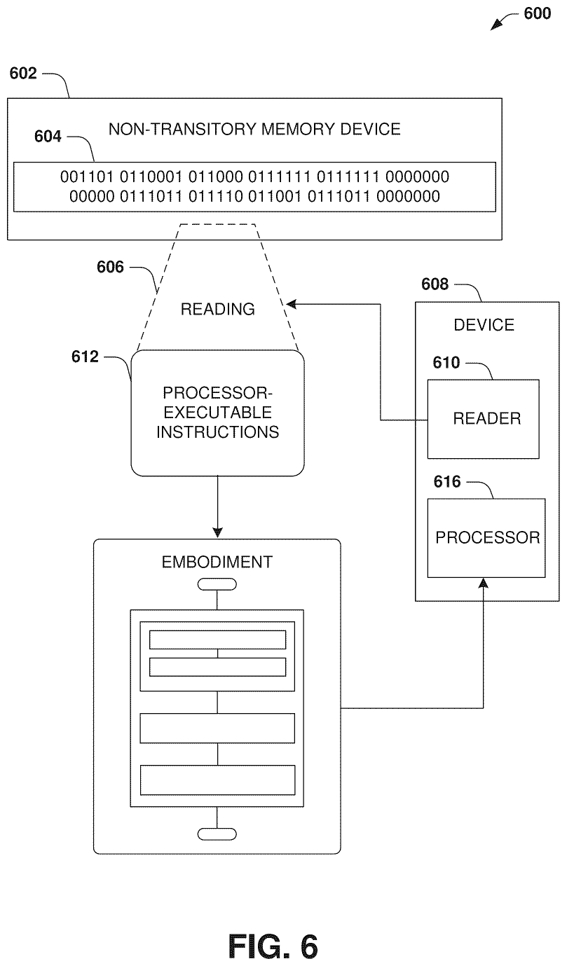

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

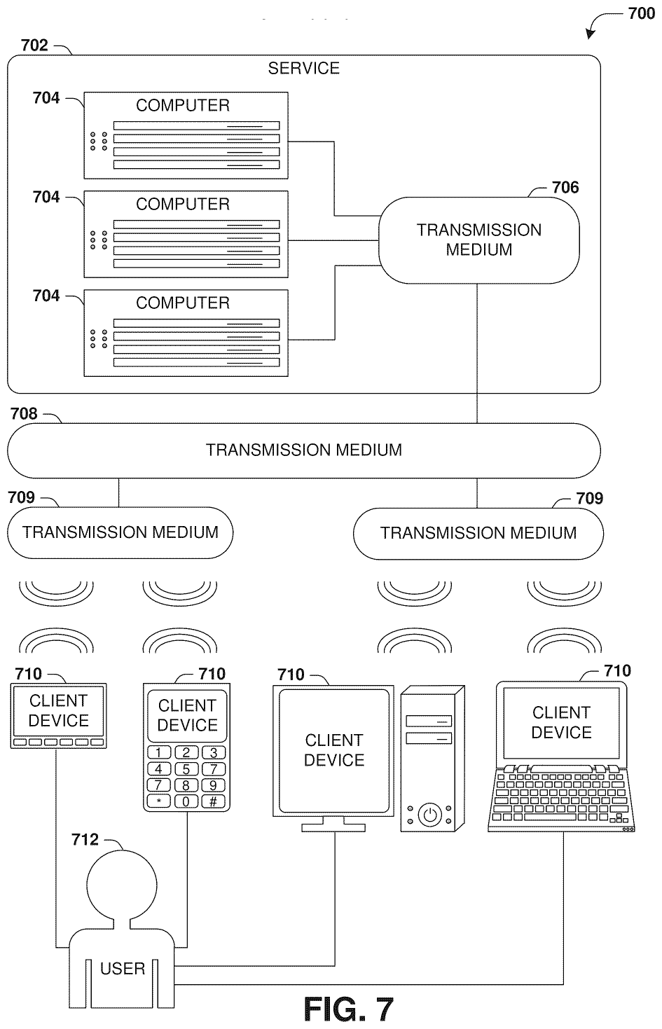

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

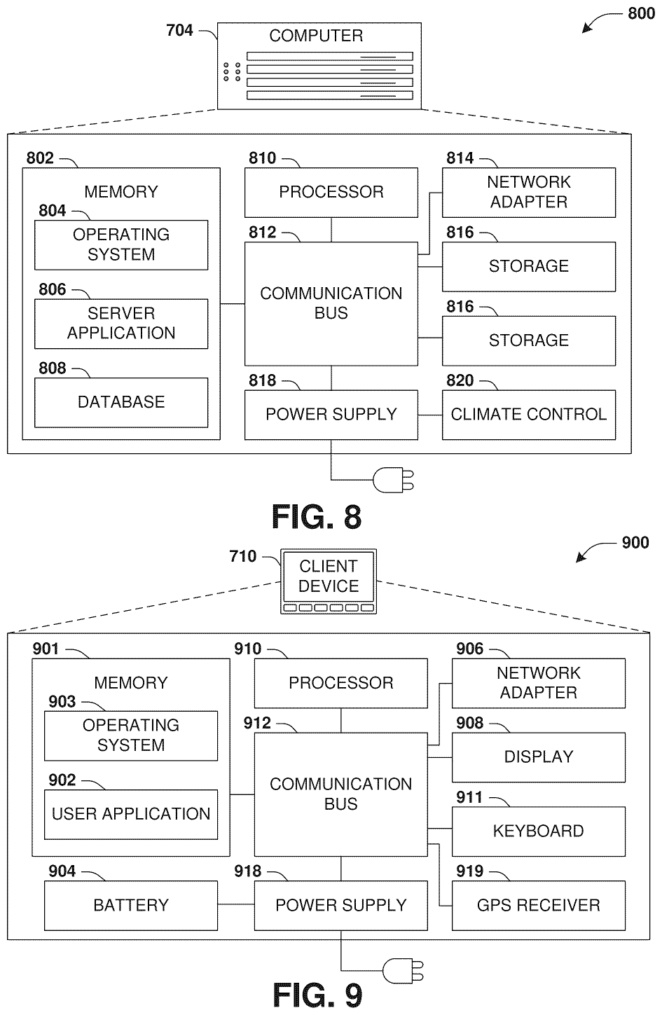

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
receiving network signals collected by devices within a location;
evaluating the network signals, by a first neural network, to generate contextually aware pixel values forming a vision map of the location;
evaluating at least one of the contextually aware pixel values or the vision map to generate a coverage map corresponding to regions of low signal coverage and obstacles proximate the regions;
executing a simulation of network equipment operating at the location based upon the coverage map to generate a simulation result; and
generating an installation plan to install the network equipment at the location based upon the simulation result.

2. The method of claim 1, wherein the evaluating the network signals comprises:
determining porosity of objects within the location based upon changes in magnitude of the network signals; and
utilizing the porosity of the objects to generate the contextually aware pixel values.

3. The method of claim 1, wherein the evaluating the network signals comprises:
evaluating phase, frequency, and time component data to measure distance of reflecting points; and
utilizing the distance of the reflecting points to generate the contextually aware pixel values.

4. The method of claim 1, wherein the evaluating the network signals comprises:
encoding the network signals, amplitude parameters, phase parameters, and frequency parameters into vectors for input into the first neural network.

5. The method of claim 1, wherein the evaluating the network signals comprises:
executing a loss function to calculate a difference between an actual value in an original image used to train the first neural network and a predicted pixel value determined by the first neural network based upon the original image; and
back-propagating the difference for training the first neural network.

6. The method of claim 1, comprising:
utilizing depth sensing from spatial map information to identify a peripheral and peripheral install location to include within the installation plan.

7. The method of claim 1, comprising:
deploying the network equipment to the location based upon the installation plan.

8. The method of claim 1, comprising:
configuring the network equipment at the location based upon the installation plan.

9. The method of claim 1, comprising:
utilizing a second neural network to train the first neural network, wherein the second neural network classifies pixels of the visual map to create pixel classifications indicating whether the pixels are synthetically generated pixels or original image pixels based upon contextually aware surrounding pixel values; and
training the first neural network based upon the pixel classifications.

10. The method of claim 9, comprising:
evaluating, by the second neural network, magnitudes of the contextually aware pixel values to identify porosity information of objects depicted by the visual map;
utilizing, by the second neural network, the porosity information to predict whether each pixel is contextually relevant or contextually irrelevant to surrounding pixels; and
flagging pixels predicted to be contextually irrelevant as flagged pixels for training the first neural network.

11. The method of claim 9, comprising:
evaluating, by the second neural network, gradients of pixels to identify shape information of objects depicted by the visual map;
utilizing, by the second neural network, the shape information to predict whether each pixel is contextually relevant or contextually irrelevant to surrounding pixels; and
flagging pixels predicted to be contextually irrelevant as flagged pixels for training the first neural network.

12. The method of claim 9, comprising:
executing a loss function to calculate a difference between an actual value in an original image used to train the first neural network and a predicted pixel value output by the first neural network; and
back-propagating the difference for training at least one of the first neural network or the second neural network.

13. A system, comprising:
one or more processors configured for executing instructions to perform operations comprising:
receiving network signals collected by devices within a location;
evaluating the network signals, by a first neural network, to generate contextually aware pixel values forming a vision map of the location;
evaluating at least one of the contextually aware pixel values or the vision map to generate a coverage map corresponding to regions of low signal coverage and obstacles proximate the regions;
executing a simulation of network equipment operating at the location based upon the coverage map to generate a simulation result; and
generating an installation plan to install the network equipment at the location based upon the simulation result.

14. The system of claim 13, wherein the operations further comprise:
utilizing a second neural network to train the first neural network, wherein the second neural network classifies pixels of the visual map to create pixel classifications indicating whether the pixels are synthetically generated pixels or original image pixels based upon contextually aware surrounding pixel values; and
training the first neural network based upon the pixel classifications.

15. The system of claim 13, wherein the operations further comprise:
transmitting the installation plan to a computing device for display through a user interface.

16. The system of claim 13, wherein the operations further comprise:
determining porosity of objects within the location based upon changes in magnitude of the network signals; and
utilizing the porosity of the objects to generate the contextually aware pixel values.

17. The system of claim 13, wherein the operations further comprise:
evaluating phase, frequency, and time component data to measure distance of reflecting points; and
utilizing the distance of the reflecting points to generate the contextually aware pixel values.

18. A non-transitory computer-readable medium storing instructions that when executed facilitate performance of operations comprising:
receiving network signals collected by devices within a location;
evaluating the network signals, by a first neural network, to generate contextually aware pixel values forming a vision map of the location;
evaluating at least one of the contextually aware pixel values or the vision map to generate a coverage map corresponding to regions of low signal coverage and obstacles proximate the regions;
executing a simulation of network equipment operating at the location based upon the coverage map to generate a simulation result; and
generating an installation plan to install the network equipment at the location based upon the simulation result.

19. The non-transitory computer-readable medium of claim 18, wherein the operations further comprise:
deploying the network equipment to the location based upon the installation plan.

20. The non-transitory computer-readable medium of claim 18, wherein the operations further comprise:
utilizing a second neural network to train the first neural network, wherein the second neural network classifies pixels of the visual map to create pixel classifications indicating whether the pixels are synthetically generated pixels or original image pixels based upon contextually aware surrounding pixel values; and
training the first neural network based upon the pixel classifications.
